(19) United States
(12) Patent Application Publication
(10) Pub. No.: US 2026/0228272 A1
(43) Pub. Date: Aug. 6, 2026

(54) MAPPING IMAGES TO WORDS FOR COMPOSED IMAGE RETRIEVAL

(71) Applicant: Google LLC, Mountain View, CA (US)

(72) Inventors: Kihyuk Sohn, Sunnyvale, CA (US); Kuniaki Saito, Allston, MA (US); Xiang Zhang, Montreal (CA); Chen-Yu Lee, Santa Clara, CA (US); Chun-Liang Li, Santa Clara, CA (US); Tomas Jon Pfister, Mountain View, CA (US)

(21) Appl. No.: 19/148,483

(22) PCT Filed: Jan. 17, 2024
(86) PCT No.: PCT/US2024/011817

§ 371 Date: Jul. 16, 2025

Related U.S. Application Data
(60) Provisional application No. 63/439,446, filed on Jan. 17, 2023.

(51) Int. Cl. G06F 16/435

(52) U.S. Cl. CPC G06F 16/435

(57) ABSTRACT

Methods, systems, and apparatus, including computer programs encoded on a computer storage medium, for composed image retrieval. In one aspect, a method performed by one or more computers is described. The method includes: receiving a query including: (i) an image depicting a scene, and (ii) a text prompt describing a context of the scene; processing the image, using a visual encoder, to generate a visual embedding of the image; processing the visual embedding of the image, using a mapping neural network, to generate one or more language tokens of the image; generating multiple language tokens of the text prompt; processing the language tokens of the image and text prompt, using a language encoder, to generate a language embedding of the query; and selecting, from a number candidate images, one or more of the candidate images using the language embedding of the query.

### CROSS-REFERENCE TO RELATED APPLICATION

This application claims priority to U.S. Provisional Patent Application No. 63/439,446, filed Jan. 17, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes an image retrieval system implemented as computer programs on one or more computers in one or more locations that can retrieve images in response to received queries, e.g., to perform composed image retrieval (CIR).

In the described examples of the image retrieval system, a query can include: (i) a query image, and (ii) a query text prompt. The query can be provided by a user, an automated system (e.g., a computer program), or both. For example, a user may wish to obtain a target image depicting a scene (e.g., including a particular object) in a desired context (e.g., with one or more additional objects present in the scene). The user can provide a query including: (i) a query image depicting the scene, and (ii) a query text prompt describing the context of the scene. The image retrieval system can process the query and retrieve one or more images that include the target image and/or variants of the target image.

The image retrieval system can retrieve highly aligned images in response to queries, that is, retrieved images that accurately produce the desired target image(s) as specified by the queries. This is because the image retrieval system can be trained and thereafter implemented in a zero-shot manner. “Zero-shot” generally refers to the type of inference the image retrieval system can perform following training. Particularly, the image retrieval system can be trained in a weakly-supervised and/or unsupervised fashion such that, at inference, the image retrieval system can process queries and retrieve images that were not included in the training dataset(s).

The image retrieval system accomplishes such CIR tasks using a visual encoder, a mapping neural network, and a language encoder. The visual encoder is configured to: receive an image; and process the image to generate a visual embedding of the image, e.g., representing the semantic content of a scene depicted in the image. The mapping neural network is configured to: receive the visual embedding of the image; and process the visual embedding to generate one or more language tokens of the image. The mapping neural network can be optimized such that the language token(s) of the image faithfully represent the visual embedding of the image in tokenized form. In this way, the image retrieval system can map the scene depicted in the image to language token(s), which can then be combined seamlessly with a text prompt describing a context of the scene. Particularly, the language encoder is configured to: receive a sequence of language tokens including: (i) the language tokens of the image, and (ii) the language tokens of the text prompt; and process the sequence of language tokens to generate a language embedding of the sequence, e.g., representing the semantic content of the scene depicted in the image, in the context described by the text prompt.

Generally, the visual and language encoders encode entities to the same embedding space, e.g., are pre-trained to maximize the similarity between visual embeddings of images and language embeddings of text descriptions of the images. As a result, the image retrieval system can retrieve candidate images that have visual embeddings aligned with the language embedding of a query, representing the combination of a query image modified by a query text prompt. This facilitates high fidelity CIR since the image retrieval system can flexibly compose query image features with text modifications to isolate candidate images that reliably produce the intended, target images.

As used herein, the term “scene” generally refers to any collection of one or more objects or generic “things” that may or may not be interacting in some way. For example, a scene may include multiple objects interacting with one another in an environment, e.g., a strawberry in a mug under the starry sky, or a brain riding a rocket ship towards the moon, or a strawberry mug filled with white sesame seeds floating in a dark chocolate sea. A scene may include a single object without a background or backdrop, or with a single-color background or backdrop, e.g., a minimal kinetic sculpture of a bird on a white background. A scene may include text or abstract art such as colors, shapes, lines, and so on, e.g., a blue flame forming text, or a watercolor-based painting.

These and other aspects of the subject matter described in this specification are summarized below.

In one aspect, a method performed by one or more computers is provided. The method includes: receiving a query including: (i) an image depicting a scene, and (ii) a text prompt describing a context of the scene; processing the image, using a visual encoder, to generate a visual embedding of the image; processing the visual embedding of the image, using a mapping neural network, to generate one or more language tokens of the image; generating a number of language tokens of the text prompt; processing the language tokens of the image and text prompt, using a language encoder, to generate a language embedding of the query; and selecting, from a number of candidate images, one or more of the candidate images using the language embedding of the query.

In some implementations of the method, processing the language tokens of the image and text prompt, using the language encoder, to generate the language embedding of the query includes: appending the one or more language tokens of the image to the language tokens of the text prompt to obtain a sequence of language tokens for the query; and processing the sequence of language tokens for the query, using the language encoder, to generate the language embedding of the query.

In some implementations of the method, selecting, from the number of candidate images, the one or more candidate images using the language embedding of the query includes: for each of the number of candidate images: processing the candidate image, using the visual encoder, to generate a visual embedding of the candidate image; and selecting, from the number of candidate images, one or more of the candidate images based on: (i) the visual embeddings of the candidate images, and (ii) the language embedding of the query.

In some implementations of the method, selecting, from the number of candidate images, one or more of the candidate images based on: (i) the visual embeddings of the candidate images, and (ii) the language embedding of the query includes: for each of the number of candidate images: calculating a similarity measure between: (i) the visual embedding of the candidate image, and (ii) the language embedding of the query; and determining a score for the candidate image based on the similarity measure; and selecting, from the number of candidate images, one or more of the candidate images based on their scores.

In some implementations of the method, selecting, from the number of candidate images, one or more of the candidate images based on their scores includes: ranking each of the number of candidate images according to their scores; and selecting, from the number of candidate images, one or more of the candidate images having the highest scores.

In some implementations of the method, the context described by the text prompt includes one or more of: (i) a domain conversion, (ii) an object and scene composition, or (iii) a sentence specification.

In some implementations of the method, the mapping neural network has been trained on training data including a number of training images that each depict a respective scene.

In some implementations of the method, the number of training images includes three million or more training images.

In some implementations of the method, the visual and language encoders are pre-trained neural networks and were held frozen during the training of the mapping neural network.

In some implementations of the method, the visual and language encoders were pre-trained on four hundred million or more image-caption pairs.

In some implementations of the method, training the mapping neural network on the training data included: for each of the number of training images: processing the training image, using the visual encoder, to generate a visual embedding of the training image; processing the visual embedding of the training image, using the mapping neural network, to generate one or more language tokens of the training image; providing a training text prompt for the training image; generating a number of language tokens of the training text prompt; and processing the language tokens of the training image and training text prompt, using the language encoder, to generate a language embedding of the training image; determining a loss of a loss function that depends on the visual and language embeddings of each training image; and updating a set of network parameters of the mapping neural network according to the loss.

In some implementations of the method, for each of the number of training images, processing the language tokens of the training image and training text prompt, using the language encoder, to generate the language embedding of the training image includes: appending the one or more language tokens of the training image to the language tokens of the training text prompt to obtain a sequence of language tokens for the training image; and processing the sequence of language tokens for the training image, using the language encoder, to generate the language embedding of the training image

In some implementations of the method, the training text prompt is the same for each of the number of training images.

In some implementations of the method, the training text prompt includes: “A photo of”.

In some implementations of the method, the loss function depends on normalized versions of the visual and language embeddings of the training images.

In some implementations of the method, the loss function includes one or more contrastive loss terms characterizing, for each training image, a similarity measure between: (i) the visual embedding of the training image, and (ii) the language embedding of the training image.

In some implementations of the method, the loss function includes symmetric contrastive loss terms.

In some implementations of the method, updating the network parameters of the mapping neural network according to the loss includes: determining values of the network parameters that minimize the loss; and updating the network parameters of the mapping neural network with the values that minimize the loss.

In a second aspect, a system including one or more computers and one or more storage devices communicatively coupled to the one or more computers is provided. The one or more storage devices store instructions that, when executed by the one or more computers, cause the one or more computers to perform operations of the any of the abovementioned methods.

In a third aspect, one or more non-transitory computer storage media is provided. The one or more non-transitory computer storage media store instructions that, when executed by one or more computers, cause the one or more computers to perform operations of the any of the abovementioned methods.

Particular embodiments of the subject matter described in this specification can be implemented so as to realize one or more of the following advantages.

The image retrieval system described in this specification can retrieve images in response to a received query, e.g., to perform composed image retrieval (CIR).

Existing solutions to CIR generally possess two shortcomings. First, existing solutions often involve a large amount of labeled data to train CIR models via supervising learning. The labeled data is usually in the form of triplets including: (i) a reference image, (ii) a text description, and (iii) a target image. The dataset collection effort typically involves two processes: (i) collecting pairs of a reference and target image to establish query-output pairs, and (ii) providing a text description that modifies the reference image to the target image. Both steps can incur a significant labeling cost. Second, CIR models trained on labeled data can be specialized to specific use-cases and may not generalize to different tasks.

In contrast, the image retrieval system described in this specification can perform diverse CIR tasks, e.g., object and scene composition, attribute editing, sentence specification, and domain conversion, without requiring an expensive labeled triplet dataset. As opposed to supervised learning, the image retrieval system can be trained via weakly-supervised learning or unsupervised learning, e.g., using large-scale weakly-labeled image-caption pairs or unlabeled images. These training methods can be considerably cheaper to implement, in terms of computational resources (e.g., compute time, memory usage, etc.), and human effort, than supervised datasets at scale, while also enabling zero-shot learning of a CIR model, referred to herein as “zero-shot composed image retrieval” (or ZS-CIR). Both of these features significantly improve the feasibility and generality of CIR for real-world applications, e.g., e-commerce and internet search.

Furthermore, the image retrieval system described in this specification can generate visual embeddings of candidate images and/or stored images for performing high fidelity CIR. Visual embeddings of candidate images provide an efficient, compact, and effective index structure for searching collections of candidate images in response to a received query. For example, candidate images can be stored in a database (e.g., a vector database) alongside their respective visual embeddings, which act as an index for searching the database using a language embedding of a query. The image retrieval system described herein can then perform vector search algorithms on the database with respect to the language embedding to efficiently retrieve candidate image(s) in response to the query. For instance, the image retrieval system can perform vector searches such as k-nearest neighbor searches (e.g., Hierarchical Navigable Small World (HNSW) searches) and Inverted File Index (IVF) searches.

The details of one or more embodiments of the subject matter described in this specification are set forth in the accompanying drawings and the description below. Other features, aspects, and advantages of the subject matter will become apparent from the description, the drawings, and the claims.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

FIG. 1 is a schematic diagram of an example image retrieval system configured to perform composed image retrieval (CIR).

FIG. 2 is a schematic diagram of an example training engine configured to train an image retrieval system.

FIG. 3A is a flow diagram of an example process for training an image retrieval system.

FIG. 3B is a flow diagram of an example process for updating a set of neural network parameters of a mapping neural network.

FIG. 4 is a schematic diagram of an example retrieval engine configured to retrieve images in response to queries using an image retrieval system.

FIG. 5A is a flow diagram of an example process for retrieving images in response to queries using an image retrieval system.

FIG. 5B is a flow diagram of an example process for selecting one or more candidate images from a set of candidate images.

FIGS. 6A-6C show examples of domain conversion, object and scene manipulation, and sentence specification tasks performed by an image retrieval system.

Like reference numbers and designations in the various drawings indicate like elements.

### DETAILED DESCRIPTION

In composed image retrieval (CIR), a user (or other entity) combines a query image with a text prompt to describe their intended, target image. Existing methods rely on supervised learning of CIR models via labeled triplets that are composed of: (i) a reference image, (ii) a text description, and (iii) a target image. Labeling such triplets is expensive and hinders broad applicability of CIR. The dataset collection effort typically involves two processes: (i) collecting pairs of a reference and target image to establish query-output pairs, and (ii) providing a text description that modifies the reference image to the target image. Both steps incur a significant labeling cost. Moreover, a neural network model trained on labeled training data is often specialized (e.g., overtrained) to specific use-cases and may not generalize to different CIR tasks, further limiting the broad application of such models.

Among other aspects, this specification introduces novel systems and methods for zero-shot CIR (ZS-CIR), allowing the construction of a CIR model that does not require labeled triplets for training. The image retrieval system described herein can be trained on large-scale weakly-labeled image-caption pairs and/or unlabeled images, which are considerably cheaper to collect than supervised training datasets at scale. Unlike existing supervised models, the image retrieval system described herein, trained via weakly-supervised and/or unsupervised learning, shows strong generalization across a diverse range of CIR tasks, such as attribute editing, object and scene composition, and domain conversion.

To utilize weakly-labeled and unlabeled datasets, this specification introduces a two-stage training engine for zero-shot learning of a CIR model. The image retrieval system described herein includes a visual encoder, a mapping neural network, and a language encoder. The training engine first pre-trains the visual and language encoders jointly on an image-caption dataset to maximize the similarity between embeddings of images and text descriptions of the images. Instead of relying on a triplet-labeled training dataset, the training engine leverages the linguistic capability of the language encoder, which is adept at generating language embeddings that are highly aligned with the corresponding visual embeddings generated by the visual encoder. The training engine then trains the mapping neural network to convert a visual embedding generated by the visual encoder into one or more language tokens that can be efficiently processed by the language encoder. Of particular note, the mapping neural network can be trained on unlabeled images to reconstruct the visual embedding. Hence, the language encoder can flexibly compose query image features and text descriptions in the language embeddings, thereby facilitating high fidelity ZS-CIR.

These and other features related to the systems and methods disclosed in this specification are described in more detail below. Further details related to the systems and methods disclosed in this specification, such as additional experiments and discussion, are provided by Orvieto, Antonio, et al. “Resurrecting recurrent neural networks for long sequences,” ar Xiv preprint arXiv: 2303.06349 (2023).

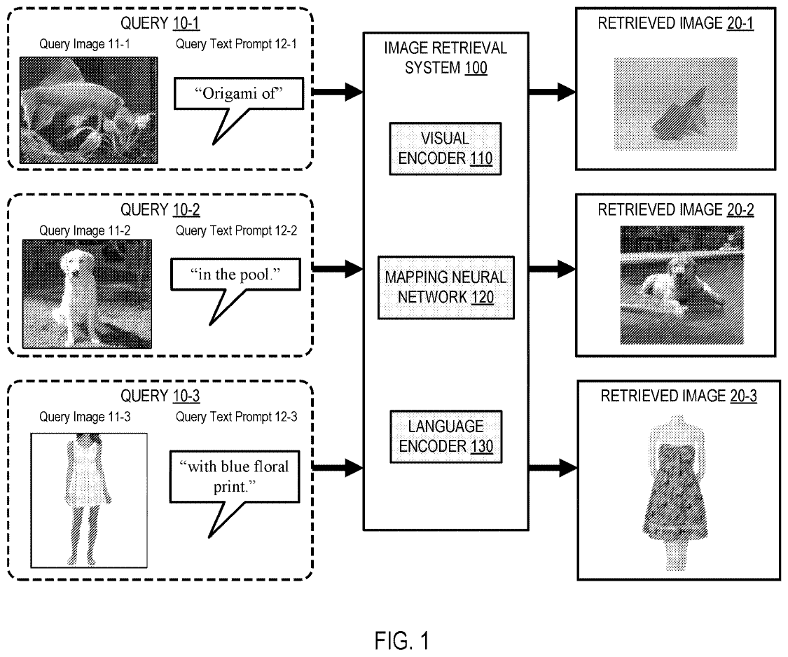

FIG. 1 is a schematic diagram of an example image retrieval system 100 configured to perform CIR. The image retrieval system 100 is an example of a system implemented as computer programs on one or more computers in one or more locations in which the systems, components, and techniques described below are implemented.

At a high-level, the image retrieval system 100 is configured to receive and process a query 10 including: (i) a query image 11 depicting a scene, and (ii) a query text prompt 12 describing a context of the scene. The image retrieval system 100 can then retrieve one or more images 20 depicting the scene in the context. The image retrieval system 100 allows retrieval of images 20 with high precision owing to the text prompt 12 that incorporates, for example, a user's intent, such as a desired modification to the query image 11. More generally, a query 10 can be provided by a user, an automated system (e.g., a computer program), or both. As one example, a user may desire a target image depicting a particular scene (e.g., including a dog) in a particular context (e.g., in a pool). The user can provide a query 10 including: (i) a query image 11 depicting the particular scene, and (ii) a query text prompt 12 describing the particular context of the scene. The image retrieval system 100 can process the query 10 and retrieve one or more images 20 that include the target image (e.g., the dog in the pool) and/or variants of the target image.

The image retrieval system 100 can be utilized for diverse real-world applications, e.g., e-commerce and internet search. The image retrieval system 100 can also perform various CIR tasks, e.g., attribute manipulation for fashion image search, composing objects, converting the style of images for content creation, among others. Moreover, the image retrieval system 100 can process and retrieve various different types of images, e.g., three-dimensional (3D) images, photorealistic images, cartoon images, abstract visualizations, point cloud images, medical images of different modalities, among others. For example, medical images can include, but are not limited to, magnetic resonance imaging (MRI) images, computed tomography (CT) images, ultrasound images, x-ray images, and so on. The types of scenes that can be depicted in query images 11 and modified by text prompts 12 is diverse, spanning from real-world settings to abstract. A few select examples are depicted in FIG. 1.

As shown in FIG. 1, for a first query 10-1, the query image 11-1 is an image of a goldfish and the query text prompt 12-1 includes “Origami of_”, where “_” represents the query image 11-1 modified by the text prompt 12-1. The image retrieval system 100 processes the query 10-1 and retrieves one or more images 20-1 of an origami goldfish. For a second query 10-2, the query image 11-2 is an image of a dog (of a specific breed) and the query text prompt 12-2 includes “_ in the pool”. The image retrieval system 100 processes the query 10-2 and retrieves one or more images 20-2 of the specific breed of dog in a pool. For a third query 10-3, the query image 11-3 is an image of a white dress and the query text prompt 12-3 includes “_ with blue floral print”. The image retrieval system 100 processes the query 10-3 and retrieves one or more images 20-3 of the dress with blue floral print.

As exemplified above, a text prompt 12 can describe a type of CIR task the image retrieval system 100 is intended to perform on the query image 11. Such CIR tasks can include, but are not limited to, domain conversions, object and scene compositions, sentence specifications, and others. A domain conversion generally refers to a text prompt 12 intended to modify the domain of the scene, e.g., converting a real-world scene to a sketch-style scene. An object and scene composition generally refers to a text prompt 12 intended to add one or more objects and/or modify the scene of the query image 11. A sentence specification generally refers to a text prompt 12 intended to modify the scene based on the sentence included in the text prompt 12.

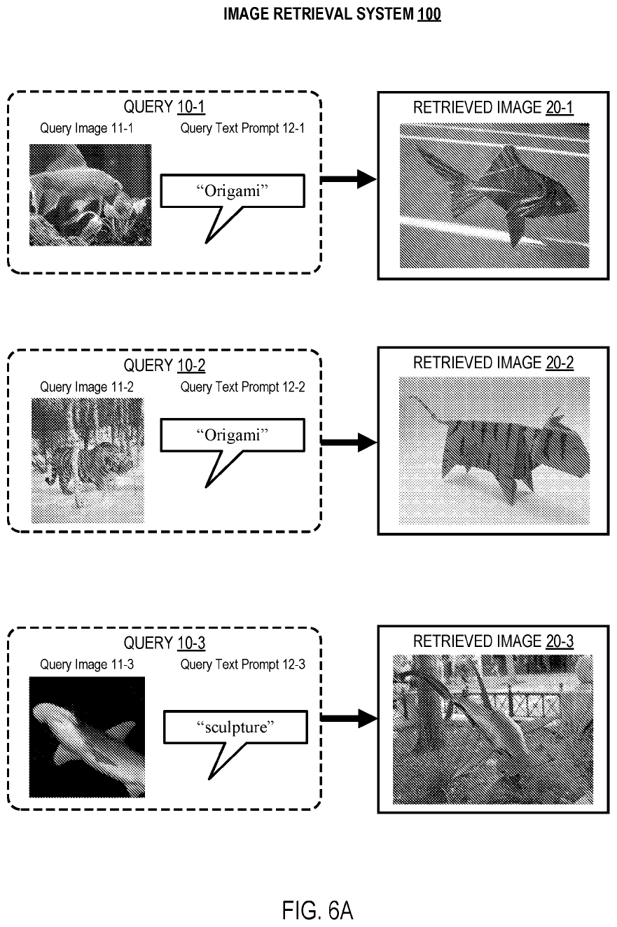

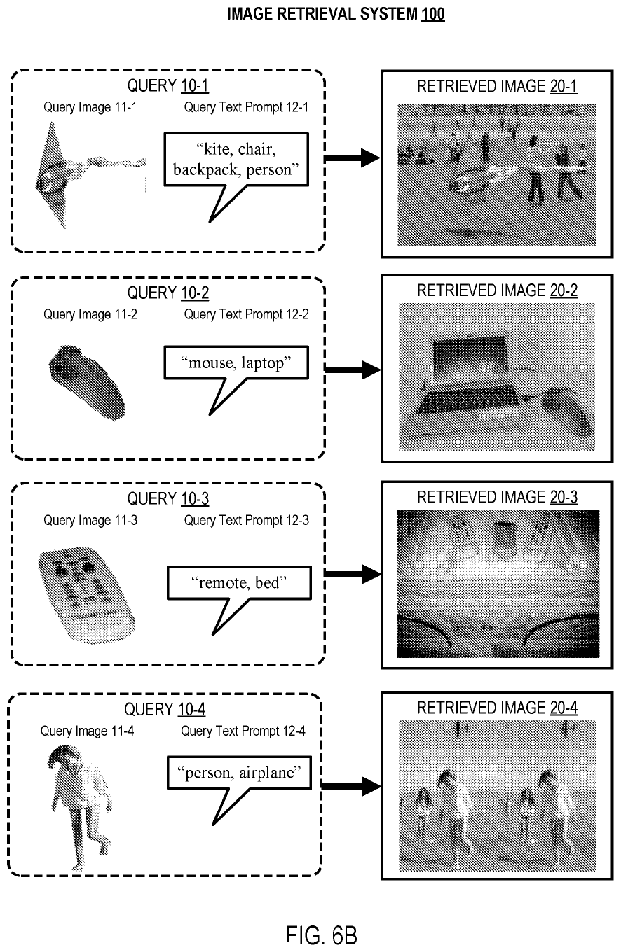

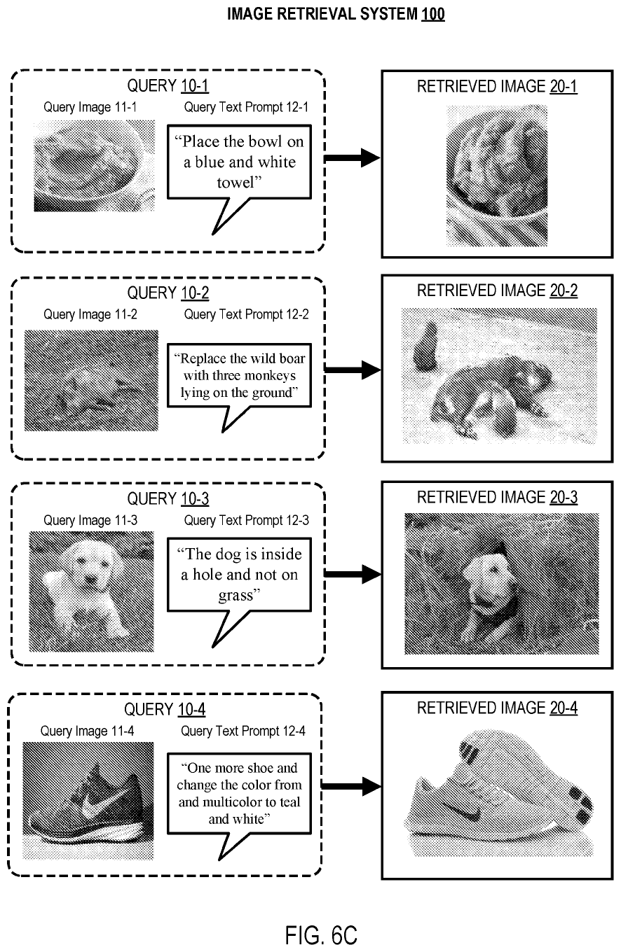

As an example of a domain conversion, if the query image 11 is a real image of a hammerhead shark and the text prompt 12 includes “A sculpture of _”, the image retrieval system 100 can process the corresponding query 10 and retrieve one or more images 20 of a sculpture of a hammerhead shark. FIG. 6A shows a few examples of domain conversions that can be performed by the image retrieval system 100.

As an example of an object and scene composition, if the query image 11 is an image of a computer mouse and the text prompt 12 includes “computer mouse, laptop”, the image retrieval system 100 can process the corresponding query 10 and retrieve one or more images 20 of the computer mouse and a laptop. FIG. 6B shows a few examples of object and scene compositions that can be performed by the image retrieval system 100.

As an example of a sentence modification, if the query image 11 is an image of a black shirt and the text prompt 12 includes “_ has a red logo”, the image retrieval system 100 can process the corresponding query 10 and retrieve one or more images 20 of the black shirt with a red logo. FIG. 6C shows a few examples of sentence specifications that can be performed by the image retrieval system 100.

Due to the flexibility of the image retrieval system 100, a query 10 can include multiple query images 11, as opposed to only a single query image. A text prompt 12 may then describe a common or related context for each of the query images 11. For example, if each query image 11 depicts a respective object, the text prompt 12 can describe a common environment for the objects, e.g., “_, _, and _ in the forest”, where each “_” represents a different query image 11 modified by the text prompt 12. The image retrieval system 100 can process the corresponding query 10 and retrieve one or more images 20 of the objects in a forest. As another example, the text prompt 12 can describe a modification to a first query image using a second, different query image, e.g., “__ with the style of _”. The image retrieval system 100 can process the corresponding query 10 and retrieve one or more images 20 of an object depicted in the first query image, rendered in the artistic style of the second query image.

To perform such CIR tasks, the image retrieval system 100 includes a visual encoder 110, a mapping neural network 120, and a language encoder 130. As an aside, the visual encoder 110 may also be referred to as an image encoder and the language encoder 130 may also be referred to as a text encoder. These terms are often used interchangeably. However, for consistency, the terms “visual encoder” and “language encoder” are adopted herein.

The visual encoder 110 is configured to: receive an image (x); and process the image to generate a visual embedding of the image (\tilde{v}=V_{φ}(x)). For example, the visual embedding of an image can represent the semantic content of a scene depicted in the image. Here, V_{φ} is a function representing a neural network model of the visual encoder 110, parametrized by a respective set of network parameters (φ).

The visual encoder 110 can have any appropriate neural network architecture that enables it to perform its described function, i.e., processing an image to generate a visual embedding of the image. In particular, the visual encoder 110 can include any appropriate types of neural network layers (e.g., fully-connected layers, convolutional layers, self-attention layers, etc.) in any appropriate numbers (e.g., 5 layers, 25 layers, or 100 layers) and connected in any appropriate configuration (e.g., as a linear sequence of layers).

The mapping neural network 120 is configured to: receive a visual embedding of an image (\tilde{v}); and process the visual embedding to generate one or more language tokens of the image (s=f_{θ}(\tilde{v})). Here, f_{θ} is a function representing the neural network model of the mapping network 120, parameterized by a respective set of network parameters (θ). In some implementations, the mapping network 120 coverts the visual embedding of an image into a single language token, e.g., a “pseudo” language token. A single language token may, in some cases, be advantageous for combination with other tokenized text. For example, the single language token representation can correspond to a word or subword token. On the other hand, multiple language tokens may, in some cases, more accurately capture the semantic content of visual embeddings, e.g., depending on the size, details, and/or information content of the visual embeddings. For example, the multiple language token representation can correspond to multiple word or subword tokens, or multiple character tokens. In any case, the mapping neural network 120 can be optimized such that the language token(s) of an image faithfully represent the visual embedding of the image in tokenized form.

The mapping neural network 120 can have any appropriate neural network architecture that enables it to perform its described function, i.e., processing a visual embedding of an image to generate one or more language tokens of the image. In particular, the mapping neural network 120 can include any appropriate types of neural network layers (e.g., fully-connected layers, convolutional layers, self-attention layers, etc.) in any appropriate numbers (e.g., 5 layers, 25 layers, or 100 layers) and connected in any appropriate configuration (e.g., as a linear sequence of layers).

The language encoder 130 is configured to: receive a sequence of language tokens (ŝ); and process the sequence of language tokens to generate a language embedding of the sequence (\tilde{p}=L_{φ}(ŝ)). The sequence of language tokens can include: (i) one or more language tokens of an image depicting a scene, and (ii) multiple language tokens of a text prompt describing a context of the scene. For example, the language token(s) of the image can be appended to the language tokens of the text prompt to obtain the sequence of language tokens. In this case, the language embedding of the sequence can represent the semantic content of the scene depicted in the image, in the context described by the text prompt. Here, L_{φ} is a function representing a neural network model of the language encoder 130, parametrized by a respective set of network parameters (φ).

The language encoder 130 can have any appropriate neural network architecture that enables it to perform its described function, i.e., processing a sequence of language tokens to generate a language embedding of the sequence. In particular, the language encoder 130 can include any appropriate types of neural network layers (e.g., fully-connected layers, convolutional layers, self-attention layers, etc.) in any appropriate numbers (e.g., 5 layers, 25 layers, or 100 layers) and connected in any appropriate configuration (e.g., as a linear sequence of layers).

Generally, the visual 110 and language 130 encoders encode entities to the same embedding space \tilde{v}, \tilde{p}∈ [symbol] ^{d×1}. In other words, the visual and language embeddings are embedding vectors having the same dimension (d). Higher dimensional embedding spaces can provide more granularity in the embeddings, e.g., encoding more contextual features of the image and language data. The image retrieval system 100 can encode to any sized embedding space, e.g., having a dimension of 10, 25, 50, 100, 200, 500, 1000, 2000, 5000, 10000, or more. Embeddings may also be referred to as encoded representations that provide computationally amenable representations for processing. In general, embeddings can be sets, vectors, or arrays of values (e.g., in UNICODE or Base64 encoding), alphanumeric values, symbols, or any convenient encoding. However, for ease of description, visual and language embeddings will be described herein according to vector representations in a (vector) embedding space.

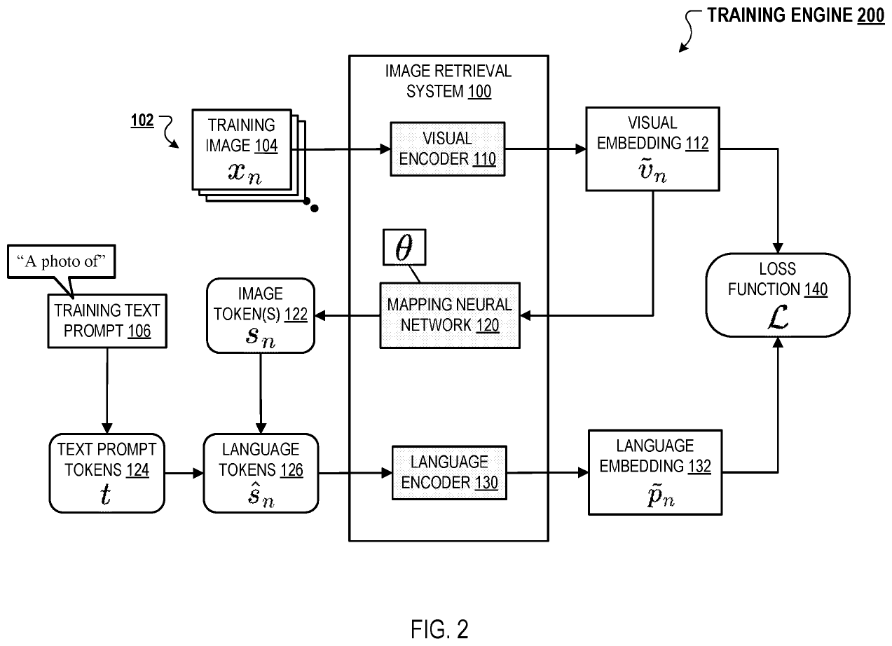

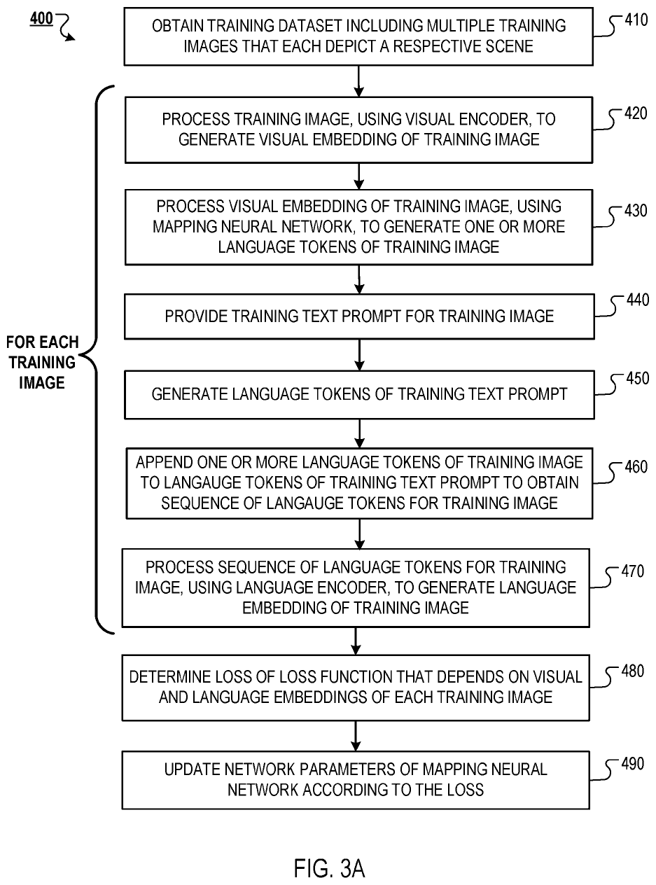

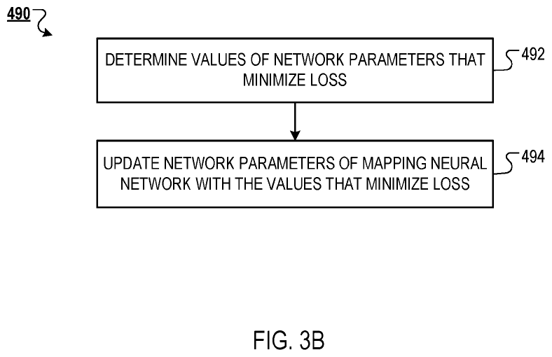

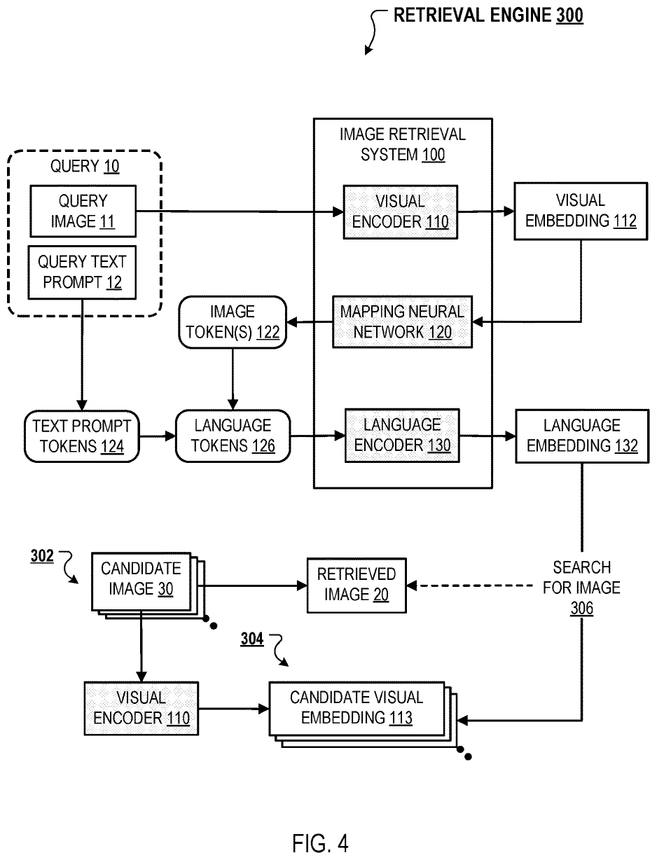

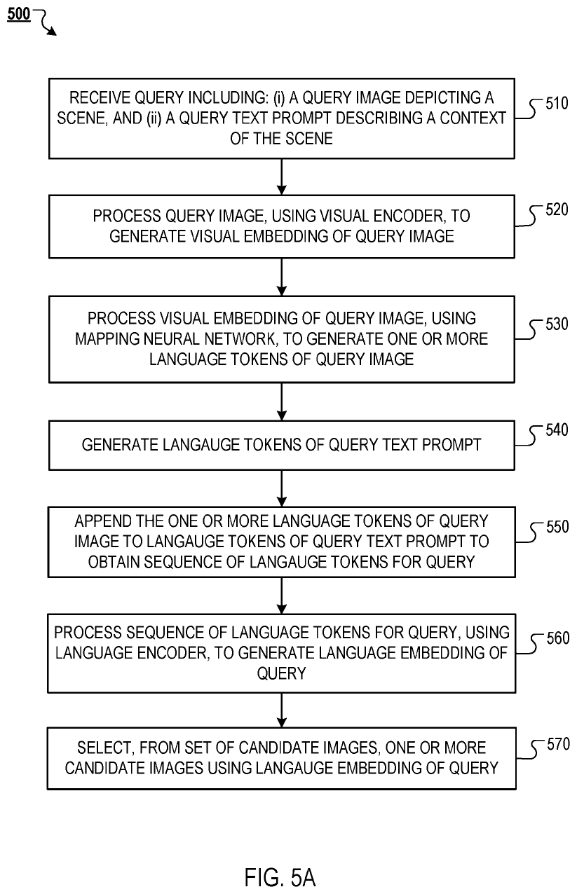

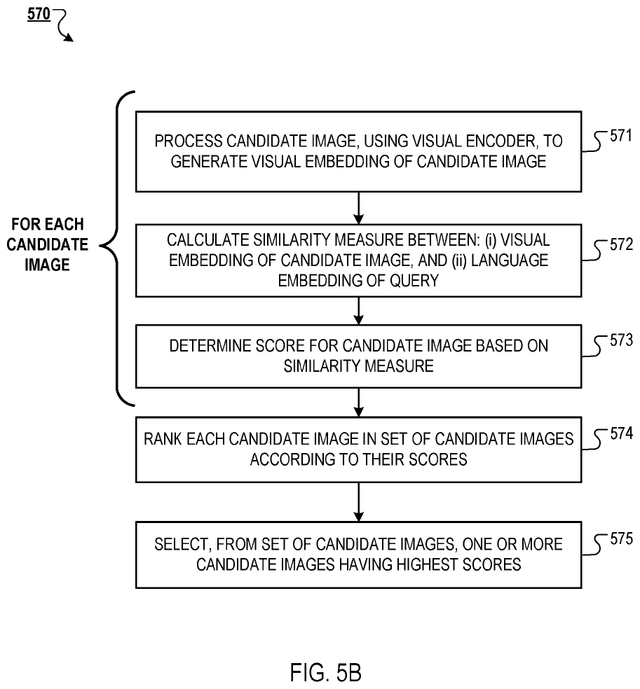

The detailed methodology for training the image retrieval system 100 is described in the following with reference to FIGS. 2-3B. Inference is described thereafter with reference to FIGS. 4-5B. In the described examples of the image retrieval system 100, a pre-trained image-text model, e.g., a Contrastive Language-Image Pre-training (CLIP) model, is utilized for the visual 110 and language 130 encoders. A more detailed review of CLIP encoders is provided by Radford, Alec, et al., “Learning Transferable Visual Models from Natural Language Supervision,” International Conference on Machine Learning, PMLR (2021). Here, the output embeddings of the visual 110 and language 130 encoders are aligned with respect to each other's modality. Given frozen and pre-trained encoders 110 and 130, the mapping neural network 120 is trained to efficiently convert a visual embedding of an image into one or more language tokens of the image. The mapping network 120 can be optimized such that the language token(s) represent the visual embedding faithfully. At inference time, the language token(s) of a query image 11 can be appended to the language tokens of a query text prompt 12. The resulting language embedding of the query 10 can then be compared to visual embeddings of candidate images for retrieval.

The image retrieval system 100 can be implemented in any appropriate location, e.g., on a user device (e.g., a mobile device), or on one or more computers in a data center, etc. The modularity of the image retrieval system 100 allows multiple devices to implement individual components of the system 100 separately from one another. For example, the visual encoder 110, mapping neural network 120, and language encoder 130 can be executed on different devices and can transmit their outputs and/or inputs to one another (e.g., via telecommunications). Users can interact with the image retrieval system 100, e.g., by providing queries to the image retrieval system 100 by way of an interface, e.g., a graphical user interface, or an application programming interface (API). In particular, a user can provide an input that includes: (i) a request to retrieve a target image, and (ii) a query 10, e.g., including one or more query images 11 and a text prompt 12, specifying the target image. In response to receiving the input, the image retrieval system 100 can retrieve one or more images 20, e.g., including the target image and/or variants of the target image, responsive to the request and provide the image(s) 20 to the user, e.g., for display on a user device of the user, or for storage in a data storage device. In some cases, the image retrieval system 100 can transmit the image(s) 20 to a user device of the user, e.g., by way of a data communication network (e.g., the internet).

FIG. 2 is a schematic diagram of an example training engine 200 configured to train the image retrieval system 100. The training engine 200 is an example of a system implemented as computer programs on one or more computers in one or more locations in which the systems, components, and techniques described below are implemented.

As mentioned above, the training engine 200 generally performs a two-stage training regime. The training engine 200 first pre-trains the visual 110 and language 130 encoders on an image-caption pre-training dataset to maximize the similarity between embeddings of images and text descriptions of the images. Thereafter, the training engine 200 trains the mapping network 120 on a weakly-labeled and/or unlabeled training dataset to learn a mapping from visual embeddings to language tokens, while holding the visual 110 and language 130 encoders frozen.

To begin, the training engine 200 obtains a pre-training dataset

$${𝒟}_{0} = {\{ ( {x}_{n} , {t}_{n} ) \}}_{n = 1}^{{N}_{0}}$$

including N₀ training examples (xₙ, tₙ). For example, the training engine 200 can sample the pre-training dataset from a repository of annotated images such as ImageNet and/or ImageNet-R. The pre-training dataset can include millions, tens of millions, hundreds of millions, or more training examples. In CLIP for example, the training engine 200 may use upwards of four hundred million training examples. Each training example is an image-caption pair including: (i) a training image (xₙ) depicting a scene, and (ii) a (tokenized) training text prompt (tₙ) describing the scene. In general, the training text prompts can be in character, word, subword, sentence, or other tokenized form of a natural language. However, for integration with the mapping neural network 120, word, subword, or character tokenization are generally preferable.

The training engine 200 processes the training image of each training example, using the visual encoder 110, to generate a visual embedding of the training image (\tilde{v}ₙ=V_{φ}(xₙ)). Along similar lines, the training engine 200 processes the training text prompt of each training example, using the language encoder 130, to generate a language embedding of the training text prompt (ũₙ=L_{φ}(tₙ)).

The training engine 200 then jointly trains the visual 110 and language 130 encoders on one or more batches ( [symbol] ) of training examples by optimizing a pre-training loss function ( [symbol] ₀) that depends on the visual and language embeddings of each training example in a batch. The training engine 200 can use various optimization techniques to optimize the pre-training loss function for a batch of training examples, e.g., stochastic gradient descent methods such as Implicit updates, Momentum, AdaGrad, RMSProp, Adam, etc.

In some implementations, the training engine 200 uses a contrastive pre-training loss function, e.g., CLIP, which is designed to find representations that match a training image to its paired text prompt while separating unpaired ones. Particularly, for an i-th training image (xᵢ) and j-th tokenized training text prompt (tⱼ) in a batch i, j∈ [symbol] , their embedding vectors are normalized as vᵢ=\tilde{v}ᵢ/∥\tilde{v}ᵢ∥ and uⱼ=ũⱼ/∥ũⱼ∥, respectively, where ∥ . . . ∥ represents the Euclidean norm. Here, the training engine 200 optimizes a symmetric contrastive loss function with respect to the network parameters φ and φ of the visual 110 and language 130 encoders:

$${min}_{\{ ϕ , φ \}} {ℒ}_{0} = {ℒ}_{01} + {ℒ}_{02} . \qquad ( 1 )$$

In other words, the training engine 200 determines the values of the network parameters for the visual 110 and language 130 encoders that minimize the associated loss in Eq. (1). For example, when implementing a stochastic gradient descent method, the training engine 200 can use backpropagation to determine gradients of the pre-training loss function with respect to the network parameters of the visual 110 and language 130 encoders. The training engine 200 can then apply an appropriate update rule, e.g., with a particular learning rate and/or weight decay, to update the network parameters using the gradients. In this case, the pre-training loss function includes two contrastive loss terms [symbol] ₀₁ and [symbol] ₀₂, with a temperature hyper-parameter (τ) that controls the strength of penalties on hard negative samples, as follows:

$${ℒ}_{01} = - \frac{1}{\vert ℬ \vert} {\sum }_{i ∈ ℬ} log \vert \frac{exp ( τ {u}_{i}^{T} {v}_{i} )}{{\sum }_{j ∈ ℬ} exp ( τ {u}_{i}^{T} {v}_{j} )} ] , \qquad ( 2 )$$

$$and ,$$

$${ℒ}_{02} = - \frac{1}{\vert ℬ \vert} {\sum }_{i ∈ ℬ} log \vert \frac{exp ( τ {v}_{i}^{T} {u}_{i} )}{{\sum }_{j ∈ ℬ} exp ( τ {v}_{i}^{T} {u}_{j} )} ] , \qquad ( 3 )$$

where | [symbol] | denotes the size of the batch. As shown in Eqs. (2) and (3), the contrastive loss terms depend on the direction of embedding vectors (but not their magnitudes). For example, terms like

$$exp ( τ {u}_{i}^{T} {v}_{j} )$$

characterize a similarity measure between a visual and language embedding as a function of a normalized scalar product (or cosine similarity) between the two. If the scalar product

$${u}_{i}^{T} {v}_{j}$$

is close to a value of 1, corresponding to parallel embedding vectors, the similarity measure is enhanced on account of the exponential. If the scalar product is close to −1, corresponding to antiparallel embedding vectors, the similarity measure is suppressed (approaching zero).

Referring now to FIG. 2, showing, schematically, how the training engine 200 trains the mapping neural network 120. The visual 110 and language 130 encoders are optimized by the training engine 200, as described above, to align visual embeddings of images with language embeddings of text prompts describing the images. Thus, one or more language tokens of an image can represent the image semantics faithfully if a language embedding of a generic text prompt appended with the language token(s) is aligned to a visual embedding of the image. To this end, the training engine 200 trains the mapping network 120 to map visual embeddings to language tokens that are compatible with the language embeddings generated by the language encoder 130.

To do so, the training engine 200 obtains a training dataset

$$𝒟 = {\{ {x}_{n} \}}_{n = 1}^{N}$$

including N training images (xₙ) that each depict a respective scene. For example, the training engine 200 can sample the training dataset from a public repository of stock images or other image source. The training dataset 102 can include the same and/or different training images than the pre-training dataset and can be of similar or dissimilar size. For example, the training dataset 102 can include one million or more, two million or more, three million or more, four million or more, five million or more, ten million or more, twenty million or more, fifty million or more, one hundred million or more training images 104. Also notice that the training dataset 102 is unlabeled, that is, does not include a respective target image for each training image 104.

The training engine 200 processes each training image 104, using the visual encoder 110, to generate a visual embedding of the training image (\tilde{v}ₙ=V_{φ}(xₙ)). Subsequently, the training engine 200 processes the visual embedding 112 of each training image 104, using the mapping neural network 120, to generate one or more language tokens of the training image (sₙ=f_{θ}(\tilde{v}ₙ)). As mentioned above, the language token(s) 122 can correspond to character, word, or subword tokens depending on the tokenized representation implemented by the image retrieval system 100.

The training engine 200 then provides a training text prompt 106 for each training image 104. Here, the training text prompt 106 is generic and identical for each training image 104. For example, the training text prompt 106 can include text descriptions such as “A photo of _”, “An image of _”, “A depiction of _”, etc., where “ ” represents the language token(s) 122 appended to the training text prompt 106. Generally, such training text prompts 106 do not offer labelling of the training images 104, that is, they do not describe any information regarding scenes depicted in the training images 104. In these cases, the training text prompt 106 may specify to the language encoder 130 that the language token(s) 122 correspond to language tokens of an actual image as opposed to, for example, a sentence. In some implementations, the training engine 200 may provide no training text prompts 106 for the training images 104, such that the language token(s) 122 are directly processed by the language encoder 130. In some implementations, the training engine 200 may provide training text prompts 106 that weakly-label the training images 104, e.g., training text prompts 106 describing the artistic-style of the training images 104, such as “A real-word photo of _”, “An abstract photo of _”, “A sketch-style photo of _”, etc.

The training engine 200 generates multiple language tokens (t) of the training text prompt 106. For instance, the training engine 200 can tokenize the training text prompt 106 using character, word, subword, sentence, or other tokenization schemes to generate the language tokens 126 of the training text prompt 106. As mentioned above, character, word, or subword tokenization may be preferable for combination with the language token(s) 122 of an image, e.g., depending on the number of language tokens the mapping network 120 is configured to output for an image.

The training engine 200 appends the language token(s) 122 of each training image 104 to the language tokens 124 of the training text prompt 106 to obtain a sequence of language tokens (ŝₙ) for the training image 104. Subsequently, the training engine 200 processes the sequence of language tokens 122 for each training image 104, using the language encoder 130, to generate a language embedding of the training image (\tilde{p}ₙ=L_{φ}(ŝₙ)).

The training engine 200 then trains the mapping neural network 120 on one or more batches ( [symbol] ) of training images by optimizing a loss function ( [symbol] ) that depends on the visual 112 and language 132 embeddings of each training image 104 in a batch. As mentioned above, the training engine 200 can use various optimization techniques to optimize the loss function 140 for a batch of training images, e.g., stochastic gradient descent methods such as Implicit updates, Momentum, AdaGrad, RMSProp, Adam, etc.

In some implementations, the training engine 200 uses a contrastive loss function 140, e.g., CLIP, which enforces the mapping network 120 to form a cycle starting from a visual embedding 112 to a corresponding language embedding 132. For an i-th training image (xᵢ) in a batch i∈ [symbol] , the visual 112 and language 132 embedding vectors of the training image are normalized as vᵢ=\tilde{v}ᵢ/∥\tilde{v}ᵢ∥ and pᵢ=\tilde{p}ᵢ/∥\tilde{p}ᵢ∥, respectively. Here, the training engine 200 optimizes a symmetric contrastive loss function 140 with respect to the network parameters θ of the mapping network 120:

$${min}_{θ} ℒ = {ℒ}_{1} + {ℒ}_{2} , \qquad ( 4 )$$

In other words, the training engine 200 determines the values of the network parameters for the mapping neural network 120 that minimize the associated loss in Eq. (4). For example, when implementing a stochastic gradient descent method, the training engine 200 can use backpropagation to determine gradients of the loss function 140 with respect to the network parameters of the mapping neural network 120. The training engine 200 can then apply an appropriate update rule, e.g., with a particular learning rate and/or weight decay, to update the network parameters using the gradients. In this case, the loss function 140 includes two contrastive loss terms [symbol] ₁ and [symbol] ₂, as follows:

$${ℒ}_{1} = - \frac{1}{\vert ℬ \vert} {\sum }_{i ∈ ℬ} log [ \frac{exp ( τ {p}_{i}^{T} {v}_{i} )}{{\sum }_{j ∈ ℬ} exp ( τ {p}_{i}^{T} {v}_{1} )} \vert , \qquad ( 5 )$$

$$and ,$$

$${ℒ}_{2} = - \frac{1}{\vert ℬ \vert} {\sum }_{i ∈ ℬ} log [ \frac{exp ( τ {v}_{i}^{T} {p}_{i} )}{{\sum }_{j ∈ ℬ} exp ( τ {v}_{i}^{T} {p}_{1} )} ] . \qquad ( 6 )$$

In this way, the training engine 200 trains the mapping network 120 to align the language embedding 132 of each training image 104 with its respective visual embedding 114, while holding the visual 110 and language 130 encoders frozen.

FIG. 3A is a flow diagram of an example process 400 for training the image retrieval system 100. For convenience, the process 400 will be described as being performed by a system of one or more computers located in one or more locations. For example, a training engine, e.g., the training engine 200 of FIG. 2, appropriately programmed in accordance with this specification, can perform the process 400.

In some implementations of the process 400, the visual 110 and language 130 encoders are pre-trained neural networks and are held frozen during the training of the mapping neural network 120. For example, the visual 110 and language 130 encoders can be neural network models based on ViT-L/14 CLIP which are pre-trained on about four hundred million image-caption pairs.

The training engine obtains a training dataset including multiple training images that each depict a respective scene (410). In some implementations of the process 400, the training dataset includes three million or more training images.

For each training image:

The training engine processes the training image, using the visual encoder 110, to generate a visual embedding of the training image (420).

The training engine processes the visual embedding of the training image, using the mapping neural network 120, to generate one or more language tokens of the training image (430).

The training engine provides a training text prompt for the training image (440). In some implementations of the process 400, the training text prompt is the same for each training image, e.g., including a generic description of each training image. For example, the training text prompt can include: “A photo of”.

The training engine generates multiple language tokens of the training text prompt (450). For example, the training engine can tokenize the training text prompt to obtain the language tokens of the training text prompt, e.g., using character, word, or subword tokenization.

The training engine appends the one or more language tokens of the training image to the language tokens of the training text prompt to obtain a sequence of language tokens for the training image (460).

The training engine processes the sequence of language tokens for the training image, using the language encoder 130, to generate a language embedding of the training image (470).

The training engine determines a loss of a loss function that depends on the visual and language embeddings of each training image (480). In some implementations of the process 400, the loss function depends on normalized versions of the visual and language embeddings of the training images. In some implementations of the process 400, the loss function includes one or more contrastive loss terms characterizing, for each training image, a similarity measure between: (i) the visual embedding of the training image, and (ii) the language embedding of the training image. For example, the loss function can include symmetric contrastive loss terms.

The training engine updates a set of network parameters of the mapping neural network 120 according to the loss (490).

FIG. 3B is a flow diagram of an example process 490 for updating the network parameters of the mapping neural network 120. For convenience, the process 490 will be described as being performed by a system of one or more computers located in one or more locations. For example, a training engine, e.g., the training engine 200 of FIG. 2, appropriately programmed in accordance with this specification, can perform the process 490.

The training engine determines values of the network parameters that minimize the loss (492).

The training engine updates the network parameters of the mapping neural network 120 with the values that minimize the loss (494). For example, the training engine can use a stochastic gradient descent method with a particular learning rate and/or weight decay, e.g., Implicit updates, Momentum, AdaGrad, RMSProp, or Adam, to update the network parameters of the mapping neural network 120.

FIG. 4 is a schematic diagram of an example retrieval engine 300 configured to retrieve images 20 in response to queries 10 using the image retrieval system 100. The retrieval engine 300 is an example of a system implemented as computer programs on one or more computers in one or more locations in which the systems, components, and techniques described below are implemented.

At inference following training, the retrieval engine 300 can receive a query 10 including: (i) a query image 11 depicting a scene, and (ii) a query text prompt 12 describing a context of the scene. The retrieval engine 300 can process the query 10, using the image retrieval system 100, to obtain a language embedding 132 of the query 10, which is represented concisely as a vector (\tilde{p}). The retrieval engine 300 then uses the language embedding 132 of the query 10 to retrieve one or more images 20 in response, e.g., that depict the scene in the context.

In more detail, the retrieval engine 300 processes the query image 11, using the visual encoder 110, to generate a visual embedding 112 of the query image 11. The retrieval engine 300 then processes the visual embedding 112 of the query image 11, using the mapping neural network 120, to generate one or more language tokens 122 of the query image 11. The retrieval engine 300 generates multiple language tokens 124 of the text prompt 12, e.g., by tokenizing the text prompt 12 as described elsewhere herein. The retrieval engine 300 then appends the language token(s) 122 of the query image 11 to the language tokens 124 of the text prompt 12 to obtain a sequence of language tokens 126 for the query 10. The retrieval engine 300 processes the sequence of language tokens 126 for the query 10, using the language encoder 130, to generate the language embedding 132 of the query 10.

Before, after, and/or in parallel, the retrieval engine 300 obtains a set of candidate images

$${\{ {x}_{k} \}}_{k = 1}^{{N}_{c}} ,$$

including N_{c} candidate images (xₖ). The retrieval engine 300 selects the one or more images 20 from the set of candidate images 302. The set of candidate images 302 may include hundreds, thousands, tens of thousands, hundreds of thousands, millions, tens of millions, or more candidate images 30 depending on the implementation. For example, the retrieval engine 300 can sample the set of candidate images 302 from a public repository of stock images (or another image source). The set of candidate images 302 may correspond to one or more classes of images in the repository. The image retrieval system 300 can isolate the one or more classes of images, e.g., cartoon, origami, toy, sculpture, desk, stove, sombrero, etc., before performing a vector search 306 on the set of candidate images 302 belonging to such classes. For instance, a user can provide an input that includes: (i) a request to retrieve a target image of a particular class, and (ii) a query 10 specifying the target image. In response to receiving the input, the retrieval engine 300 can sample the set of candidate images 302 corresponding to the particular class and thereafter retrieve one or more images 20 from the set 302, as described below, responsive to the request. Alternatively, or in addition, the retrieval engine 300 can use the query 10 to determine the one or more classes of images. For example, the retrieval engine 300 can perform a reverse image search with respect to the query image 10 and/or a keyword search with respect to the text prompt 12 to determine the one or more classes. After obtaining the set of candidate images 302, the retrieval engine 300 then uses the language embedding 132 of the query 10 to retrieve one or more images 20 from the set 302.

In more detail, the retrieval engine 300 processes each candidate image 30 in the set 302, using the visual encoder 110, to generate a visual embedding (\tilde{v}ₖ) of the candidate image 30. The retrieval engine 300 then performs a vector search 306 on the set of candidate images 302 with respect to the visual embeddings 113 of the candidate images 30 and the language embedding 132 of the query 10. Particularly, the retrieval engine 300 calculates a respective similarity measure (αₖ) between: (i) the language embedding 132 of the query 10, and (ii) the visual embedding 113 of each candidate image 30 in the set 302. For example, the retrieval engine 300 can compute a cosine similarity

$$( {α}_{k} = {v}_{k}^{T} p )$$

or other appropriate similarity measure for each candidate image 30. The retrieval engine 300 can then determine a respective score (σₖ) for each candidate image 30 based on its similarity measure with the query 10. For example, the score for a candidate image 30 can be a linear or nonlinear function of its respective similarity measure, such as an exponential function σₖ=exp(ταₖ) or a logistic function σₖ=[1+exp(−ταₖ)]⁻¹. The retrieval engine 300 then ranks the candidate images 30 according to their scores, e.g., from least to greatest relative values, selecting one or more of the candidate images 30 with the highest scores as output 20 in response to the query 10.

In some implementations, the retrieval engine 300 maintains a database of candidate images 30, e.g., a vector database. In these implementations, the image retrieval engine 300 can processes each candidate image 30 in the database, using the visual encoder 110, to generate a visual embedding (\tilde{v}ₖ) of the candidate image 30 in advance of a query 10 being received. The resulting visual embeddings 113 can be stored alongside their respective candidate images 30 in the database. Particularly, candidate images 30 having visual embeddings 113 that are similar to one another can be arranged nearest one another, e.g., according to a cosine similarity or inverse distance metric between the visual embeddings 113. The retrieval engine 300 can then use the visual embeddings 113 as an index for searching the database efficiently for candidate images 30 relevant to a query 10. For example, when the retrieval engine 300 generates a language embedding 132 of a query 10, the retrieval engine 300 can perform the vector search algorithm 306 on the database of candidate images 30 with respect to the language embedding 132. Examples of vector search algorithms 306 that can be performed by the retrieval engine 300 include, but are not limited to, k-nearest-neighbor searches (e.g., Hierarchical Navigable Small World (HNSW) searches) and Inverted File Index (IVF) searches. This can significantly increase the speed of vector searches 306 performed by the retrieval engine 300, for instance, such that not every visual embedding 113 stored in the database needs to be evaluated against the language embedding 132 like in a brute force search.

Note, in situations when the query 10 includes multiple query images 11, the operations of the retrieval engine 300 follows similar steps. In these cases, the retrieval engine 300 processes each query image 11 in the query 10, using the visual encoder 110 and mapping neural network 120, to generate one or more language tokens 122 of the query image 11. The retrieval engine 300 then appends the language token(s) 122 of each query image 11 to the language tokens 122 of the text prompt 12 to obtain the sequence of language tokens 126 for the query 10. This is subsequently processed by the language encoder 130 to generate the language embedding 132 of the query 10 that represents, for example, the combination of the query images 11 modified by the text prompt 12. (Examples of multi-image text prompts 12 are described with reference to FIG. 1). The retrieval engine 300 can then retrieve one or more images 20, as described above (e.g., FIG. 4), using the language embedding 132 of the multi-image query 10.

FIG. 5A is a flow diagram of an example process 500 for retrieving images in response to queries using the image retrieval system 100. For convenience, the process 500 will be described as being performed by a system of one or more computers located in one or more locations. For example, a retrieval engine, e.g., the retrieval engine 300 of FIG. 4, appropriately programmed in accordance with this specification, can perform the process 500.

The retrieval engine receives a query including: (i) an image depicting a scene, and (ii) a text prompt describing a context of the scene (510). For example, the context described by the text prompt can include one or more of: (i) a domain conversion, (ii) an object and scene composition, or (iii) a sentence specification.

The retrieval engine processes the image, using the visual encoder 110, to generate a visual embedding of the image (520).

The retrieval engine processes the visual embedding of the image, using the mapping neural network 120, to generate one or more language tokens of the image (530).

The retrieval engine generates multiple language tokens of the text prompt (540). For example, the retrieval engine can tokenize the text prompt to obtain the language tokens of the text prompt, e.g., using character, word, or subword tokenization.

The retrieval engine appends the one or more language tokens of the image to the language tokens of the text prompt to obtain a sequence of language tokens for the query (550).

The retrieval engine processes the sequence of language tokens for the query, using the language encoder 130, to generate the language embedding of the query (560).

The retrieval engine selects, from a set of candidate images, one or more of the candidate images using the language embedding of the query (570).

FIG. 5B is a flow diagram of an example process 570 for selecting one or more candidate images from a set of candidate images using a language embedding of a query. For convenience, the process 570 will be described as being performed by a system of one or more computers located in one or more locations. For example, a retrieval engine, e.g., the retrieval engine 300 of FIG. 4, appropriately programmed in accordance with this specification, can perform the process 570.

For each candidate image:

The retrieval engine processes the candidate image, using the visual encoder 110, to generate a visual embedding of the candidate image (571).

The retrieval engine calculates a similarity measure between: (i) the visual embedding of the candidate image, and (ii) the language embedding of the query (572).

The retrieval engine determines a score for the candidate image based on the similarity measure (573).

The retrieval engine ranks each of the candidate images in the set according to their scores (574).

The retrieval engine selects, from the set of candidate images, one or more of the candidate images having the highest scores (575).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a query comprising: (i) an image depicting a scene, and (ii) a text prompt describing a context of the scene;
processing the image, using a visual encoder, to generate a visual embedding of the image;
processing the visual embedding of the image, using a mapping neural network, to generate one or more language tokens of the image;
generating a plurality of language tokens of the text prompt;
processing the language tokens of the image and text prompt, using a language encoder, to generate a language embedding of the query; and
selecting, from a plurality of candidate images, one or more of the candidate images using the language embedding of the query.

2. The method of claim 1, wherein processing the language tokens of the image and text prompt, using the language encoder, to generate the language embedding of the query comprises:
appending the one or more language tokens of the image to the language tokens of the text prompt to obtain a sequence of language tokens for the query; and
processing the sequence of language tokens for the query, using the language encoder, to generate the language embedding of the query.

3. The method of claim 1, wherein selecting, from the plurality of candidate images, one or more of the candidate images using the language embedding of the query comprises:
for each of the plurality of candidate images:
processing the candidate image, using the visual encoder, to generate a visual embedding of the candidate image; and
selecting, from the plurality of candidate images, one or more of the candidate images based on: (i) the visual embeddings of the candidate images, and (ii) the language embedding of the query.

4. The method of claim 3, wherein selecting, from the plurality of candidate images, one or more of the candidate images based on: (i) the visual embeddings of the candidate images, and (ii) the language embedding of the query comprises:
for each of the plurality of candidate images:
calculating a similarity measure between: (i) the visual embedding of the candidate image, and (ii) the language embedding of the query; and
determining a score for the candidate image based on the similarity measure; and
selecting, from the plurality of candidate images, one or more of the candidate images based on their scores.

5. The method of claim 4, wherein selecting, from the plurality of candidate images, one or more of the candidate images based on their scores comprises:
ranking each of the plurality of candidate images according to their scores; and
selecting, from the plurality of candidate images, one or more of the candidate images having the highest scores.

6. The method of claim 1, wherein the context described by the text prompt comprises one or more of: (i) a domain conversion, (ii) an object and scene composition, or (iii) a sentence specification.

7. The method of claim 1, wherein the mapping neural network has been trained on training data comprising a plurality of training images that each depict a respective scene.

8. The method of claim 7, wherein the plurality of training images comprises three million or more training images.

9. The method of claim 7, wherein the visual and language encoders are pre-trained neural networks and were held frozen during the training of the mapping neural network.

10. The method of claim 9, wherein the visual and language encoders were pre-trained on four hundred million or more image-caption pairs.

11. The method of claim 7, wherein training the mapping neural network on the training data comprised:
for each of the plurality of training images:
processing the training image, using the visual encoder, to generate a visual embedding of the training image;
processing the visual embedding of the training image, using the mapping neural network, to generate one or more language tokens of the training image;
providing a training text prompt for the training image;
generating a plurality of language tokens of the training text prompt; and
processing the language tokens of the training image and training text prompt, using the language encoder, to generate a language embedding of the training image;
determining a loss of a loss function that depends on the visual and language embeddings of each training image; and
updating a set of network parameters of the mapping neural network according to the loss.

12. The method of claim 11, wherein for each of the plurality of training images, processing the language tokens of the training image and training text prompt, using the language encoder, to generate the language embedding of the training image comprises:
appending the one or more language tokens of the training image to the language tokens of the training text prompt to obtain a sequence of language tokens for the training image; and
processing the sequence of language tokens for the training image, using the language encoder, to generate the language embedding of the training image.

13. The method of claim 11, wherein the training text prompt is the same for each of the plurality of training images.

14. The method of claim 13, wherein the training text prompt comprises: “A photo of”.

15. The method of claim 11, wherein the loss function depends on normalized versions of the visual and language embeddings of the training images.

16. The method of claim 11, wherein the loss function comprises one or more contrastive loss terms characterizing, for each training image, a similarity measure between: (i) the visual embedding of the training image, and (ii) the language embedding of the training image.

17. The method of claim 16, wherein the loss function comprises symmetric contrastive loss terms.

18. The method of claim 11, wherein updating the network parameters of the mapping neural network according to the loss comprises:
determining values of the network parameters that minimize the loss; and
updating the network parameters of the mapping neural network with the values that minimize the loss.

19. A system, comprising:
one or more computers; and
one or more storage devices communicatively coupled to the one or more computers, wherein the one or more storage devices store instructions that, when executed by the one or more computers, cause the one or more computers to perform operations comprising:
receiving a query comprising: (i) an image depicting a scene, and (ii) a text prompt describing a context of the scene;
processing the image, using a visual encoder, to generate a visual embedding of the image;
processing the visual embedding of the image, using a mapping neural network, to generate one or more language tokens of the image;
generating a plurality of language tokens of the text prompt;
processing the language tokens of the image and text prompt, using a language encoder, to generate a language embedding of the query; and
selecting, from a plurality of candidate images, one or more of the candidate images using the language embedding of the query.

20. One or more non-transitory computer storage media storing instructions that, when executed by one or more computers, cause the one or more computers to perform operations comprising:
receiving a query comprising: (i) an image depicting a scene, and (ii) a text prompt describing a context of the scene;
processing the image, using a visual encoder, to generate a visual embedding of the image;
processing the visual embedding of the image, using a mapping neural network, to generate one or more language tokens of the image;
generating a plurality of language tokens of the text prompt;
processing the language tokens of the image and text prompt, using a language encoder, to generate a language embedding of the query; and
selecting, from a plurality of candidate images, one or more of the candidate images using the language embedding of the query.
